(19) United States
(12) Patent Application Publication
(10) Pub. No.: US 2011/0003085 A1
(43) Pub. Date: Jan. 6, 2011

(54) Production Of Tailored Metal Oxide Materials Using A Reaction Sol-Gel Approach

(75) Inventors: Treese Hugener-Campbell, Coventry, CT (US); Thomas Henry Vanderspurt, Glastonbury, CT (US); Wayde R. Schmidt, Pomfret Center, CT (US); Steven M. Zhitnik, West Hartford, CT (US)

Correspondence Address: Cantor Colburn LLP - Carrier, 20 Church Street, 22nd Floor, Hartford, CT, 06103, US

(73) Assignee: CARRIER CORPORATION, Farmington, CT (US)

(21) Appl. No.: 12/876,642

(22) Filed: Sep. 7, 2010

Related U.S. Application Data
(63) Continuation of application No. PCT/US2009/039510, filed on Apr. 3, 2009.
(60) Provisional application No. 61/123,085, filed on Apr. 4, 2008.

(51) Int. Cl. B05D 1/04; C01B 13/32; C01G 19/02; C01G 15/00; C01G 9/02; C01G 49/02; C01F 17/00; C01G 53/04; C01G 51/04; C01G 17/00; C01G 25/02; C01G 33/00; C01G 41/02; C01G 47/00; C01B 33/12; B05D 1/02; B05D 1/18; B05D 3/10; C01G 27/02; C01G 35/00; C01G 39/02

(52) U.S. Cl. 427/458; 423/592.1; 423/618; 423/624; 423/622; 423/632; 423/263; 423/594.19; 423/608; 423/594.17; 423/606; 423/605; 423/335; 427/427; 427/430.1; 427/372.2

(57) ABSTRACT

A porous metal oxide is formed by creating a metal oxide material with a hydrolysis reaction in solution. The hydrolysis reaction or reaction products of a metal oxide precursor react simultaneously or in conjunction with a metal salt or a disassociation species of a metal salt. The metal oxide material is conditioned, and is refined to produce metal oxide particles having a porous structure containing crystallites.

### CROSS REFERENCE TO RELATED APPLICATIONS

This application is a continuation of International Application No. PCT/US2009/039510 filed Apr. 3, 2009, the entire contents of which are incorporated herein by reference, which claims priority to U.S. Provisional Application No. 61/123,085 filed Apr. 4, 2008, the entire contents of which are incorporated herein by reference.

### FIELD OF THE INVENTION

This invention relates generally to the preparation of porous metal oxides. More specifically, the present invention relates to a modified sol gel method of making metal oxides containing a tailored pore structure.

### BACKGROUND

Porous materials are commonly used in catalyses, separation technologies, electrode applications and sensor applications. The preparation of porous materials can be accomplished mainly by two different routes: thermally treating hydrous metal oxides; and the removal of surfactant, oligomeric and polymeric templates.

### SUMMARY

A metal oxide powder comprised of porous particles is formed from a modified sol gel process. The sol gel process includes template creation, template conditioning, template refinement, and coating application.

The template creation utilizes a hydrolysis reaction using a metal oxide precursor within an aqueous solution that includes a polymer, surfactant, oligomer, or chelating agent. The solution may also include an organic or inorganic acid, and a metal salt that when combined with oxygen forms a metal oxide. The ions from the solvated metal salt may form an organometallic species from reaction with the organic or inorganic acid. Following the hydrolysis reaction, the sol may be aged to achieve the desired surface area and pore size.

Template conditioning of the metal oxide material produced by the hydrolysis reaction results in the isolation, purification and “locking in” of the solid material with a specific template. Template conditioning may include filtering and refluxing with a solvent having a lower surface tension than water.

Template refinement transforms the template structure into a material having a specific phase composition, crystallinity, surface area and pore size distribution. Template refinement may include an optional low temperature drying step followed by a high temperature calcination step.

Coating application is performed by mixing the powder obtained from calcination with dispersing fluid to form a slurry. The slurry is then applied to a substrate.

### BRIEF DESCRIPTION OF THE DRAWINGS

FIG. 1 is a diagrammatic illustration of a metal oxide film formed of porous particles.

FIG. 2 is a flow diagram of a process for making large surface area metal oxide particles and coatings.

FIG. 3 is a flow diagram illustrating a specific example of the process of FIG. 2.

FIG. 4 is a graph showing deactivation rate as a function of surface area of pores having a diameter of equal to or greater than 4 nm for different UV photocatalysts.

FIG. 5 is a graph showing a desorption hysteresis loop for a titanium dioxide based photocatalyst material formed with neodymium acetylacetone as a metal salt additive.

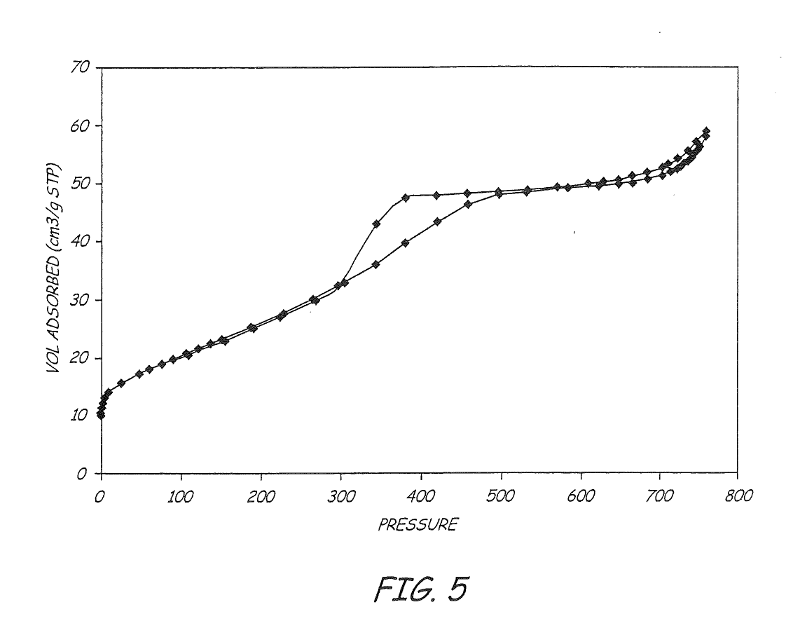

FIG. 6 is a graph showing a desorption hysteresis loop for a titanium dioxide based photocatalyst material formed with zinc (II) acetate hydrate as a metal salt additive.

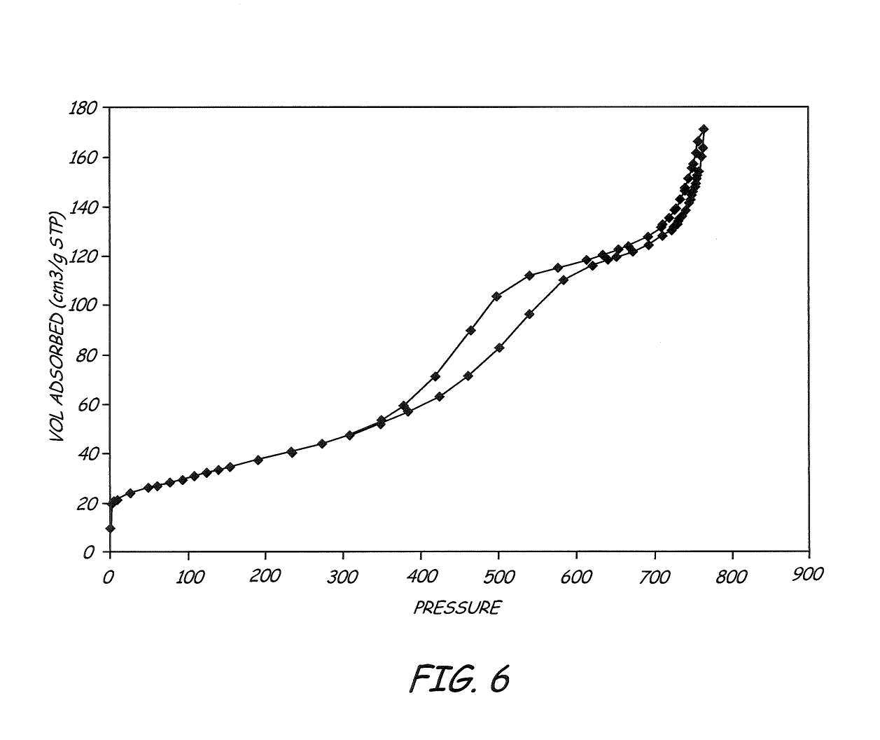

### DETAILED DESCRIPTION

Tailored porous metal oxide particles may be used in many different applications including catalysis, separation technology, electrodes and sensors. In one application, deactivation resistant photocatalysts can be formulated by layering one or more photocatalysts on a suitable substrate such as, but not limited to, an aluminum honeycomb. These deactivation resistant photocatalysts may also be used in so-called backside illumination designs where the photocatalyst is deposited on light pipes, light carrying fibers or structures, where the photons enter from the photocatalytic layer opposite that which is exposed to the fluid flow.

Metal oxides include but are not limited to metal oxides of cobalt, gallium, germanium, hafnium, iron, nickel, niobium, molybdenum, lanthanum, rhenium, scandium, silicon, tantalum, titanium, tungsten, yttrium and zirconium; suitably doped titanium dioxide where the dopant increases the photocatalytic activity; metal oxide grafted titanium dioxide catalysts such as, but not limited, to tungsten oxide grafted TiO2; and mixed metal oxides such as, but not limited to, tin oxide (SnO2), indium oxide (In2O3), zinc oxide (ZnO), iron oxides (FeO and Fe2O3), neodymium oxide (Nd2O3) and cerium oxide (CeO2).

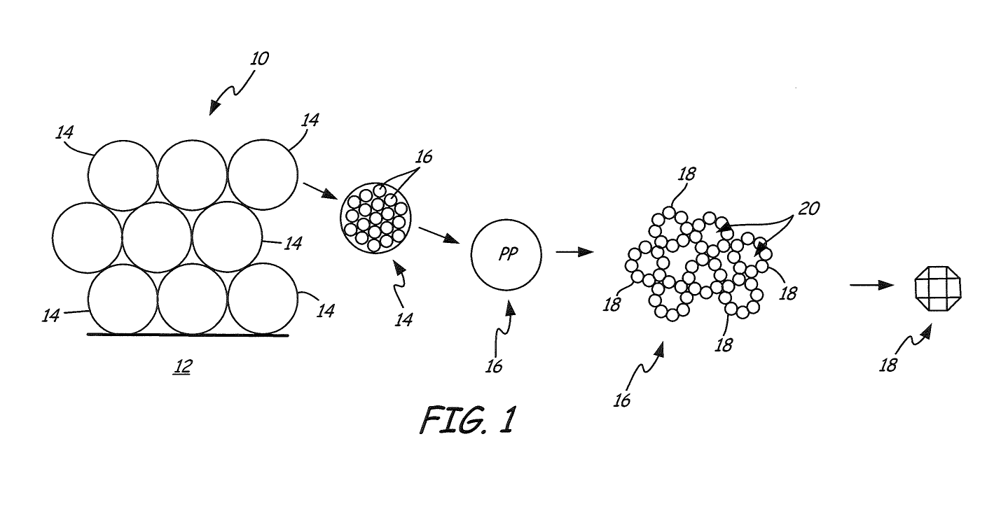

FIG. 1 illustrates one exemplarily structure of a tailored porous metal oxide. In FIG. 1, metal oxide film 10 is deposited on substrate 12 made up of clusters 14 of porous particles 16. Crystallites 18 and pores 20 form the porous structure of porous particles 16. In one example, crystallites 18 are formed of wide band gap semiconductor material, for example, having a band gap of greater than about 3.1 eV. Pores 20 are interconnected to form a three-dimensional pore network within porous particles 16.

In one example, crystallites 18 are greater than about 2 nm in diameter, and pores 20 are about 4 nm or greater in diameter. In another example, there are about 104 crystallites 18 per porous particle 16, and the diameter of porous particle 16 is approximately 100 nm. In a further example, clusters 14 of porous particles 16 have a diameter on the order of about 1 micron to about 2 microns. The overall thickness of film 10 depends on the application. In one example where film 10 was a photocatalyst film, the overall thickness of film 10 was between about 2 to about 12 microns. In another example where film 10 was a photocatalyst film, the overall thickness of film 10 was about 3 to about 6 microns.

The porous structure of particle 16 provides a large surface area, large pore metal oxide. In photocatalytic applications, pores 20 are believed to provide available void space for deposition or location of non-volatile compounds of silicon and oxygen resulting from a conversion of the volatile silicone-containing species, so that the non-volatile products do not block active sites on the photocatalyst. As a result, the deactivation of the photocatalyst is reduced.

The pore diameter may be measured by the BJH technique that is well known to those skilled in the art and is typically an option on automated surface area determination equipment. The original reference describing the BJH technique is E. P. Barrett, L. G. Joyner, P. P. Halenda, J. Am. Chem. Soc. 73, (1951), 373-380.

For titanium dioxide, higher surface area in pores substantially less than 4 nm in diameter did not increase the resistance to deactivation by siloxanes. For adequate photocatalytic activity, the crystallites of the wide band gap semiconductor (or semiconductors) that make up this porous structure must possess sufficient size (typically greater than about 2 nm in diameter) and the appropriate degree of crystallite perfection to allow adequate electron-hole separation to occur. According to Degussa Technical Information TI 1243, March 2002, P25 titania has a BET surface area of 50 m2/g and consists of aggregated primary particles with an average size of 21 nm. Of these primary particles, 80% are anatase, and 20% are rutile. The anatase particles tend to be somewhat smaller and the rutile somewhat larger. In practice P25 titania based photocatalytic material has a measured BET specific surface area of between about 44 m2/g and about 55 m2/g. BET surface area is described in S. Brunauer, P. H. Emmett, and E. Teller, J. Am. Chem. Soc. 60, (1938), 309-319.

Since specific surface area is measured in m2/gram, the surface area has to be corrected for the potentially different densities of different metal oxides. For example, the anatase form of TiO2 has a density of 3.84 m2/g, while rutile form has a density of 4.26 m2/g. In contrast, tin oxide (SnO2) as cassiterite has a density of 6.95 m2/g, while zinc oxide (zincite) has a density of 5.61 m2/g. Thus, to convert to m2/cm3 of skeletal volume, an 80% anatase 20% rutile mix has a surface area per cm3 of skeletal volume of [(0.8×3.84 g/cm3)+(0.2×4.26 g/cm3)]*50 m2/g=196.2 m2/cm3.

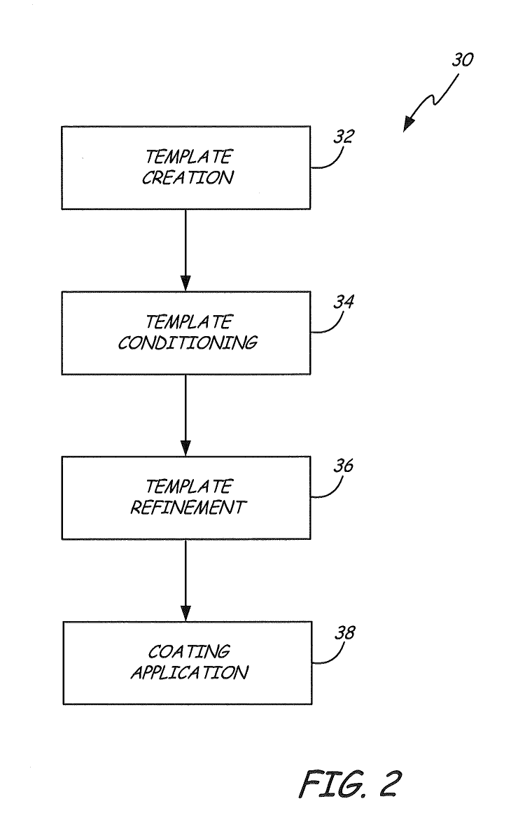

FIG. 2 illustrates process 30 for forming a film having porous metal oxide particles made up of nano-sized crystallites in a large pore, high surface area structure. The process makes use of sol-gel chemistry to create porous particles with the desired crystallite and pore structure and the desired population of pore sizes. Process 30 includes four basic steps: template creation 32, template conditioning 34, template refinement 36 and coating application 38. Although process 30 is discussed with respect to titanium dioxide and titanium precursors, other metal oxides may be formed as will be discussed later.

Template creation 32 of the nano-engineered porous metal oxide particles is dependent upon several factors, which include the choice of an organometallic precursor, composition of solvent medium, control of the hydrolysis of an organometallic precursor, control of condensation reactions that occur concurrently or after hydrolysis of the organometallic precursor, and the time needed to age a sol to create a template for a material that has a surface area greater than 50 m2/g with well defined pores.

Substituents on the organometallic precursor are expected to contribute to the hydrolysis reaction in the following manner in an aqueous solvent with no additives: halogens will hydrolyze faster than isoproxide which will hydrolyze faster than t-butoxide.

Coordination of the organometallic precursor can affect the amount of oligomerization than could occur after hydrolysis and ultimately will affect the gel structure.

The concentration of the precursor should decrease the rate of hydrolysis when the precursor is diluted with a solvent that does not interact with the precursor. Interaction with the dilution solvent would mean that hydrolysis has started prematurely before contact with the intended solution.

Purity of the organometallic precursor has not been observed to be critical in the synthesis. For example, the titanium organometallic precursor has not been observed to be critical in the synthesis of about 100 to about 130 m2/g titanium oxide with a controlled pore distribution. Titanium isopropoxide of 97% to 99.999% purity has been used with no differences in the overall reaction product.

The rate of addition of the organometallic precursor can also control the hydrolysis reaction in such a manner that the faster the addition, the faster the hydrolysis in an aqueous solution. For example, using titanium isopropoxide and conditions described for the standard example, a rate of 4 drops/5 sec has been found to produce a titanium oxide material with a surface area>100 m2/g and the incremental surface area was greater than 15 m2/g. Increasing the rate of addition produces a lower surface area titanium oxide.

The rate of hydrolysis is also affected by the medium in which the hydrolysis reaction occurs. When aqueous or protic or polar solvents are used as the bulk medium, hydrolysis would be expected to occur, whereas non-aqueous or aprotic or non-polar solvents would not participate in hydrolysis. A combination of small aliquot of aqueous, protic or polar solvent rapidly mixed with large volume of nonaqueous, aprotic or non-polar solvent would result in a medium where a controlled hydrolysis could occur due to the dilution of the reactive medium.

The pH of a medium will also affect the rate of hydrolysis of the organometallic precursor such that the hydrolysis reaction will occur at a faster rate in acidic environments. The pH of the medium can be critical to the concentration, shape, and size of the dynamic entanglements that result from the polymer interactions with the medium.

The choice of polymer present in the bulk medium may affect the hydrolysis rate if the polymer changes the pH or viscosity of the bulk medium. The choice of polymer and solvent will result in the formation of dynamic entanglements of the polymer that will influence the size and shape of the hydrolysis and condensation products. In general, polymers interact with solvent by either an attraction to the solvent, repulsion to a solvent, or the polymer chain reaches an equilibrium state with the solvent. When the polymer is attracted to solvent, the polymer chains are extended away from other polymer chains and large void spaces within the polymer chains result. In a solvent that lacks attraction to a polymer chain, the polymer chains are more attracted to other polymer chains, and the void spaces are smaller than those void spaces that would exist if polymer chains were more attracted to a solvent. Another means of phrasing the previous example is that the polymer chains collapse on and amongst other polymer chains. Under equilibrium conditions, or theta solvent conditions, the void spaces of the polymer chains result from the balance of attractive and repulsive forces existing in the polymer solvent solution. All of the above described scenarios are affected by temperature.

The addition of metal salts to an aqueous solution would be expected to provide additional interaction with the polymer solvent interactions, and thus contribute to changes in the resulting void space which ultimately affects phase, shape, surface area, particle size and pore size distribution of the end material. In an aqueous solution, the dissociation of the metal salt results in the separation of the cation and anion species. Depending on the nature of the ionic species and the reactivity of the anion and cation, further reaction with the solvent (e.g., acid) can result in the formation of a new chemical present in solution that can interact with the existing polymer. For example, when tin fluoride is added to an aqueous 1M acetic acid solution containing polyethylene glycol (PEG), the dissociation of the salt results in the formation of tin and fluoride ions. When the initial drop of an organometallic precursor is added, the hydrolysis reaction that occurs also initiates an addition reaction where the tin ions combine with acetate ions to form tin(II)acetate. Acetate ions are much larger than tin or fluoride ions, the size of tin(II)acetate would be the equivalent of the diameter of one tin atom plus two acetate molecules. The tin(II) acetate is a large bulky spacer group that can interact and hence orient the PEG in solution.

The type of salt can also influence the final material. If the salt contains the cation of a known semiconductor oxide, then incorporation of the salt into metal vacancies of the main metal oxide material may result in a material with a band gap that is altered from both the parent metal oxide (material being produced) and cation-based metal oxide. A similar scenario would exist for non-oxide based metal salts as long as the necessary anion was incorporated into the parent material.

After the hydrolysis reaction is complete, the aging of the sol is critical for formation of the polymer network and the crystallization of the metal oxide particles formed. Differences in surface area and pore size distribution result when aging time varies from 0 hours to 3 weeks. For example for titanium dioxide particles, aging times under 72 hours result in materials with lower surface areas (<100 m2/g) and incremental pore areas under 15 m2/g, and aging times over 168 hours do not produce dramatic improvements in surface area or incremental pore area compared to aging for 72 hours. Higher surface areas and incremental pore areas are obtained when the sol is gently stirred over the duration of aging. In the absence of stirring during the aging process, a material with lower surface area and incremental pore area is obtained i.e., less than 100 m2/g and incremental pore area under 15 m2/g for titanium dioxide particles.

The pore diameter may be measured by the BJH technique that is well known to those skilled in the art and is typically an option on automated surface area determination equipment.

Template conditioning 34 results in the isolation, purification and a “locking in” of the solid material with a specific template after the template creation step. After isolation of the solid from the liquid sol, residual water and potentially other impurities from the sol are removed and the solid is isolated under reduced pressure.

Isolation of the solid produced in the sol during template formation, may be accomplished for example, by vacuum filtration, gravity filtration, or centrifugation. The resulting solid may also be isolated under reduced pressure e.g., rotoevaporation, however the affect of pressure will alter the template of the solid such that in the case of titanium oxide, materials with lower surface areas (<100 m2/g) and incremental pore areas under 15 m2/g will result. Depending on the composition of the sol, the isolated solid may need to be washed with small aliquots of solvent several times to remove potential contaminants or undesirable materials that could ultimately prevent the formation of a desired phase, structure, crystallinity, etc.

Reflux of the isolated solid with a solvent that has a lower surface tension than water results in the removal of water and water-based impurities trapped internally within the solid providing that the solvent is protic or aprotic. For solvents that have a higher surface tension than water, it is believed that solvent would become trapped within vacant pores and limit the surface area and pore size distribution of the resulting material.

Time of reflux is proportional to the amount of water removed. For example a one hour reflux time will remove more water than a reflux time of 15 min. After reflux times of one hour or greater, the solid particles form an emulsion within the solvent water mixture and solid particles do not appear to settle up to 24 hours post reflux.

The volume of solvent used for reflux should always be in excess of the amount of water or water-based impurities that are predicted to be removed. For 10 g of solid material, 300 ml of solvent would be appropriate to perform a successful reflux. A repeat reflux step can ultimately result in additional removal of water and/or water based impurities. In order to repeat reflux, the solid must be isolated by filtration or centrifugation means. Solvent removal at reduced pressure prior to reflux would negatively alter the template and result in material with lower surface areas (<100 m2/g) and incremental pore areas under 15 m2/g in the case of titanium oxide materials.

The solid in the emulsion created in the reflux step must be isolated under reduced pressure to “lock-in” a structure template. In the case of titanium oxide, by removing solvent so that the solvent is distilled off at 40° C., a suitable template is produced that after refinement can result in a material having a surface area greater than 100 m2/g and an incremental pore area of 15 m2/g or greater.

It is believed that under reduced pressure, the organic and polymer components “lock” the placement of the titanium oxide network. The application of higher distillation temperatures and pressures result in a collapse of the network for titanium dioxide, while the use of lower temperatures and pressures may not effectively remove solvent from the solid material. Failure to remove solvent will result in a decrease of surface area and incremental pore area.

Template refinement 36 of the template structure may include an optional low temperature drying step followed by a high temperature calcination step. For some preparations a low temperature drying step is critical for removal of residual solvent vapors. A high temperature calcination step will transform the template structure into a material with a specific phase composition, crystallinity, particle size, surface area, and pore size distribution.

Depending on the polymer type, polymer concentration and reflux solvent, a low temperature (i.e., 100° C. or less), reduced pressure drying step may be necessary to remove residual contaminants. For examples where titanium oxide was produced, preparations that used polymer amounts greater than 4 g or preparations that did not use a metal salt had higher surface areas when a 12 hours vacuum drying step was employed prior to calcination. When 4 g of polymer, and 1.5 g of metal salt were used, a vacuum drying step resulted in lower surface area after calcination.

Calcination is done either following the isolation of the material by rotoevaporation or after a low temperature drying step is implemented. Calcination temperature is critical to produce a desired phase. For titanium oxide, temperatures above 700° C. typically produce a photochemically inactive rutile phase, and temperatures between 300° C. to 600° C. will produce an anatase phase which is regarded to be photochemically active.

Coupled with temperature are the rate of heating, duration of heating, and atmosphere of calcination. All of the mentioned variables are critical for control of phase, crystallinity, surface area, and pore size.

The following calcination examples apply to a titanium oxide material prepared by the hydrolysis of titanium isopropoxide in an aqueous acidic PEG 4600, tin fluoride medium and worked up by isolation of the solid, 1 hour reflux, removal of solvent by at 40° C. under reduced pressure.

For calcination experiments of 4 hours (at temperature) with a constant air purge at a heating rate of 3° C./min:

At 400° C., the resulting surface area was less than 100 m2/g and the incremental surface area was less than 15 m2/g. The presence of organic material was evident by the brown discoloration on the powder (powder should be white) and verified by thermogravimetric analysis.

At 500° C. and 550° C., the resulting surface area was greater than 100 m2/g and the incremental surface area was greater than 15 m2/g. Two to three pore size distributions exist from 0 nm to 50 nm. Materials produced are greater than 95% anatase with 5% rutile. Crystallite size has been measured using powder X-ray diffraction at approximately 13 nm.

At 700° C., the resulting surface area is under 50 m2/g, incremental pore area is less than 5 m2/g. Compared to the above calcination experiments where there are two distinct pore size distributions, at 700° C., five pore size distributions exist over a range of 0 nm to 100 nm. The major phase for this material is expected to be anatase. Crystallite size is predicted to be greater than 13 nm.

The atmosphere in which the calcination occurs can influence the phase, crystallinity, surface area, and pore size. Ideally for the decomposition of organic matter, it is conducive to have an oxygen rich environment. At 500° C., there is no substantial difference in surface area or incremental pore area when using air compared to using a 50/50 mixture of O2/N2. Despite the lack of change in surface area, one may expect changes in crystal size and phase.

Coating application 38 uses the powder obtained after calcinations. The powder is mixed with a solvent to prepare a slurry. This slurry is applied to a substrate, and can be further dried.

The critical steps in the preparation of the slurry pertain to the reduction of agglomerates within the solution and the extent of incorporation of the solid powder into a solvent. Agglomerates in the powder may be reduced by sonication in a desired solvent or centrifugal mixing with appropriate milling media. Critical to all agglomeration methods is the ability to not introduce additional contamination.

Incorporation of the solid into the solvent may be accomplished by the use of but not limited to mechanical stirring, centrifugal mixing, magnetic stirring, high shear mixing.

The slurry can be applied to a substrate by spray coating, dip coating, electrostatic coating or thermal treatment to a substrate. The coated substrate can be dried at room temperature, dried on hot contact, or vacuum dried at either room or elevated temperature.

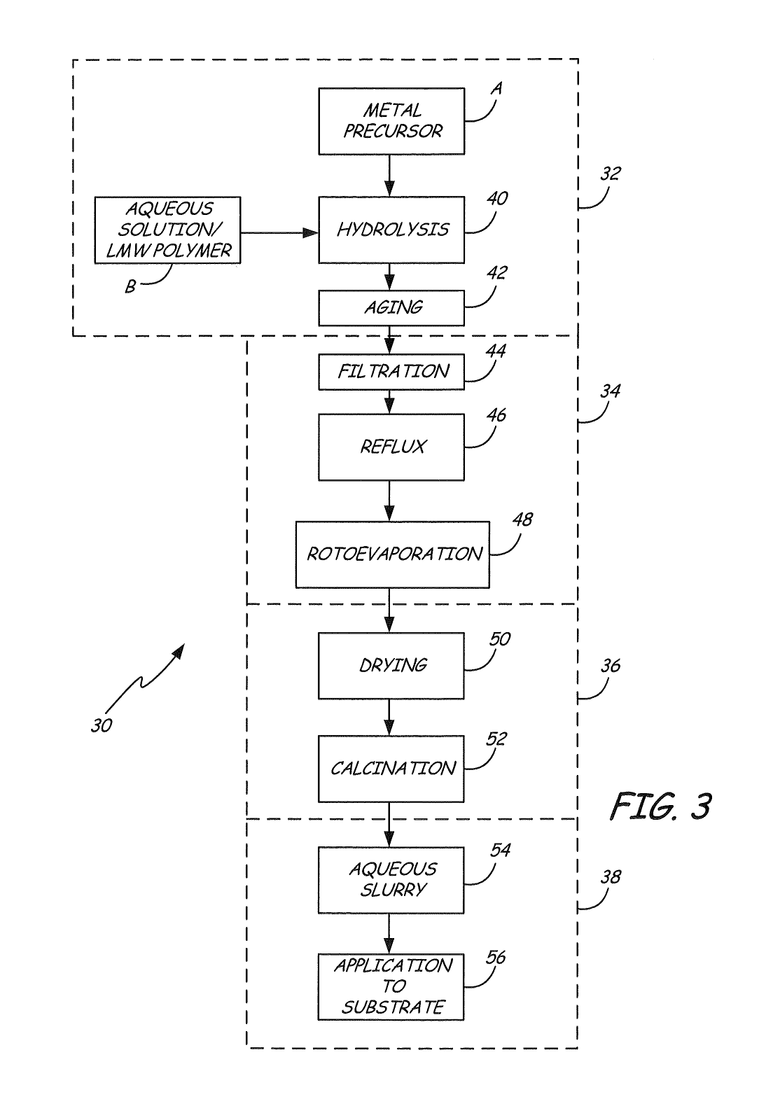

FIG. 3 illustrates a specific example of process 30. Template creation 32 begins with the addition of a metal oxide precursor A to a solution B to produce controlled hydrolysis reaction 40. When the metal oxide is a wide band gap oxide semiconductor containing titanium dioxide, metal oxide precursor A is a titanium precursor that may be, for example, a titanium alkoxide or halide such as titanium isopropoxide, titanium butoxide, or titanium tetrachloride or other such compounds. Solution B includes one or more low molecular weight polymer component, one or more solvents and one or more metal salts.

The polymer component may be, for example, polyethylene glycol with a number average molecular weight (Mn) such as 200, 500, 2000, 4600, or 10,000. The polymer component may also include surfactants and chelating agents, such as citric acid, urea, poloxyethyleneglycol (e.g. Brij®) surfactants, an ethylene oxide/propylene oxide block copolymer (e.g. Pluronic 123®), polyvinyl alcohol, polyvinyl acetate, D-sorbitol and other hydroxyl-containing compounds. Other polymers, oligomers, surfactants, or chelating agents that contain chemical functionalities that can interact with the reaction contituents may be used as it is believed that the polymer, oligomer, surfactant or chelating agent contributes to the initial gel structure which contributes to (directs or creates a template for) the resulting particle morphology and structure during calcination.

Solvents may include, but are not limited to water, alcohols or organic-based solvents or mixtures thereof. In one example, the solvent is water with controlled concentrations of added acid, base or salt. For example, the acid may be an organic acid such as acetic acid (e.g. 1M, 4M, 0.5M, 0.25M) or an inorganic acid such as hydrochloric acid (1M). The base may be sodium hydroxide (1M) or other metal oxide bases or ammonium bases such as ammonium hydroxide. The salt may be sodium chloride (1M) or other salts.

The solution may also include one or more additional metal salts, wherein the metal is one that, when combined with oxygen, forms a wide band gap metal oxide semiconductor. Examples of metal salts include tin(IV) fluoride, iron(II) acetylacetonate, iron(III) acetylacetonate, neodymium(III) acetylacetonate, zinc(II) acetate hydrate, and cerium(IV) fluoride. It is believed that the addition of a metal salt contributes to the formation of a discrete porous network, and may also contribute to increased photocatalytic activity compared to commercial titanium oxide materials.

Other salts, acids and bases (and combinations thereof) may be used as long as the interaction between the salt, solvent and polymer results in less than 5 populations of discrete pore size distributions in the isolated photocatalyst, which is material isolated following removal of the salt, solvent and polymer. The combination of polymer, salt, and solvent is important as the interactions between the solvent and the polymer are believed to control initial formation and structure of the gel network.

Depending on the choice of solvent, polymer chains in solution will adopt dynamic random conformations that will result in regions varying in polymer concentration. These regions may be defined by globules or coils. Globules are regions of high polymer concentration where polymer chains are dense, compact and possess minimal void spaces. Coils are more relaxed regions of polymer chains where void spaces are present. It is believed that the hydrolysis reaction of the metal precursor occurs within the confines of the polymer void spaces. A metal salt, such as tin fluoride, in the solution, can dissociate into ions and further interact with other components in solution or titanium dioxide produced by the hydrolysis of the initial titanium precursor. The resulting chemical species formed from the dissociation of the metal salt can either act as spacers or as crystal surface control agents. In addition, the resulting tin oxide semiconductor, in conjunction with the titanium dioxide semiconductor, may yield enhanced photocatalytic activity. When tin fluoride is introduced into an aqueous acetic acid solution, it dissociates, and tin acetate is formed. The addition of titanium-based precursors into this aqueous solution starts a chemical reaction and forms oxidized titanium products, such as titanium dioxide.

A typical example of the above described catalyst would be when 20 ml of titanium isopropoxide, 99%, is hydrolyzed in a solution containing 100 ml of aqueous 1M Acetic acid, 4.00 g of 4400-4800 Mn polyethylene glycol, and 1.5 g of tin(II) fluoride, 99%. The combination of the polymer, the acetic acid, and the tin acetate form a dynamic entanglement, and the voids within the entanglement are most likely where the crystallites of titanium dioxide form. As a result, the titanium dioxide is surrounded by regions of polyethylene glycol, acetate, and hydroxyl groups from water and from polyethylene glycol.

When the hydrolysis reaction is complete, the sol is aged (step 42). Aging times range from about 0 hours to about 3 weeks, and preferably are in a range of about 72 hours to about 168 hours. The sol may be stirred during the aging process.

Template conditioning 34 isolates, purifies and locks in the catalyst material with a specific template. It includes filtration (step 44), reflux (step 46) and rotoevaporation (step 48).

The hydrolysis reaction (step 40) and subsequent aging (step 42) produces a dispersion or mixture of powder and solution. The mixture is filtered (step 44), and is then refluxed in the presences of alcohol or aprotic solvent to remove some of the water that remains in the material, most likely inside the pores (step 46). Water has a high surface energy, and is expected to cause some of the pores to collapse as the solid structure is dried. Alcohol, on the other hand, typically has a lower surface tension, and is expected to readily evaporate without collapsing the pore structure of particle 16.

Reflux of the mixture (step 46) is then followed by solvent removal, preferably using reduced pressure methods, such as rotoevaporation process (step 48). It is desirable to control the pressure used to remove the solvent, such that the solvent vapor distillation will occur at a controlled temperature. In one example, the pressure during solvent removal was controlled so that solvent vapor was distilled at 40° C.

Template refinement 36 includes optional drying (step 50) and calcination (step 52). The product may be dried, preferably at pressures below one atmosphere, to remove most of the non-metal oxide material (step 50). Drying takes place under reduced pressures at a temperature typically between about 25° C. and about 100° C. In one embodiment, drying is performed for about 2 days at about 75° C., under conditions in which low vapor pressure impurities are removed. Various desirable combinations of time, temperature and pressure can be used to carefully control the drying and to remove the non-metal oxide materials to a content below about 10% by weight.

Calcination is performed at temperatures in a range of about 350° C. to about 700° C. (step 52). In one embodiment, the product is heated from room temperature to about 500° C. at a rate of about 3° C. per minute. The temperature is then held at about 500° C. for about four to about 18 hours, and then is reduced back to room temperature. The calcination step removes any residual non-metal oxide materials, so that the resulting porous particles are about 100 nm in diameter and are made up of crystallites, such as wide band gap oxide semiconductor crystallites, in a pore structure having pores of diameter 4 nm or larger.

During calcination, oxygen enrichment may be used to assist in the removal of organic materials. The oxygen enrichment, however, is controlled so that it does not for example trigger an exothermic oxidation and cause a transition from the anatase phase of TiO2 to the rutile phase.

As a result of calcination, the product is in the form of a white powder, with porous particles forming clusters of about 1 micron to about 2 micron diameter.

Coating application 38 includes aqueous slurry formation (step 54) and application to a substrate (step 56). The powder is mixed with water or organic solvent to form a slurry having approximately 1-20 wt % solids (step 54). The slurry is then applied to substrate by spraying, dip coating, or other application technique (step 56). Solvent evaporates, leaving the film. In one example the film is a photocatalyst film having a thickness on the order of about 3 microns to about 6 microns thickness. In another example the film is a photocatalyst film having approximately 1 milligram catalyst per square centimeter. Greater than about 1 milligram per square centimeter does not significantly increase the photocatalytic properties of the film. An amount significantly less 1 milligram per square centimeter will result in a lower photocatalytic effect.

### EXAMPLES

The following examples illustrate the benefits a photocatalyst formed from tailored porous titanium dioxide particles.

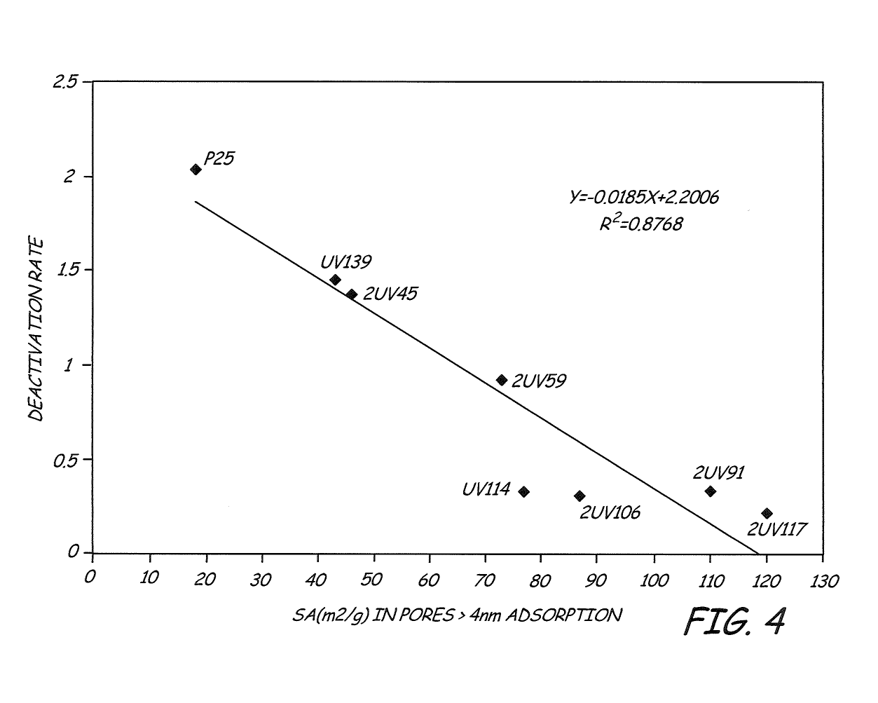

FIG. 4 is a graph showing deactivation rate, in relative units, as a function of cumulative surface area in pores of greater than 4 nm diameter for conventional P25 photocatalyst and for photocatalysts (designated UV114, UV139, 2UV45, 2UV59, 2UV91, 2UV106 and 2UV117) made using the process shown in FIG. 2. The deactivation rate was determined by the comparison of single pass activity exposing each photocatalyst to propenal, and then to hexamethyldisiloxate.

The data point for conventional P25 titanium dioxide photocatalyst shows a deactivation rate of slightly greater than 2 and a cumulative surface area of less than 20 m2/g in pores of greater than 4 nm in diameter. In contrast, all of the other photocatalyst exhibited a deactivation rate of 1.5 or lower and the surface area of 40 m2/g or greater in pores of greater than 4 nm diameter. These represent show a deactivation rate greater than 2, where deactivation rate is defined as the % single pass efficiency decrease per hour.

UV139 is a photocatalyst according to the process shown in FIG. 2 using polyethylene glycol with Mn=4600, acetic acid, and titanium isopropoxide. The aqueous solution used in making UV139 did not include a metal salt.

In separate experiments, photocatalyst 2UV45, 2UV59, and UV114 were formed using the method with polyethylene glycol, acetic acid, titanium isopropoxide, and with tin fluoride as the metal salt in the aqueous solution. For each of samples 2UV45, 2UV59, and UV114, during solvent removal using rotoevaporation, a reduced pressure was used.

In separate experiments for preparing samples 2UV91, 2UV106, and 2UV117, the vacuum during rotoevaporation was controlled to 137 millibar. Sample 2UV91 was a batch using four grams of polyethylene glycol (Mn=4600); 1.5 grams tin fluoride; 100 milliliters acetic acid (1M); and 20 milliliters titanium isopropoxide (97% solution). Samples 2UV106 and 2UV117 used the same components in twice the quantity.

All of the synthesized photocatalysts had increased photocatalytic efficiency compared to Degussa P25 titania as a result of surface area greater than 50 m2/g, a discrete number of high population pore diameters, e.g., one, two or three different pore diameter populations as opposed to Degussa P25 that has greater than five populations of pore diameters. In addition to improved photocatalytic activity, the synthesized photocatalysts also exhibited improved resistance to siloxane contamination compared to the commercial P25 titanium oxide photocatalyst.

1 ppm propanal was oxidized by UV-A light at 50% relative humidity under conditions where initially about 20% of the propanol was oxidized. The deactivation agent was 90 ppb hexamethyldisiloxane. Under these conditions increasing the surface area of pores greater than 4 nm from 18.5 m2/g (˜72.6 m2/cm3 by BJH N2 adsorption in P25 titania) to 77.8 m2/g, (i.e., ˜298.8 m2/cm3) in tin doped anatase TiO2 (designated UV114) decreased the rate of deactivation from 2.05% initial activity/hr for P25 to 0.335% initial activity/hr for UV114. Thus the P25 titania would drop to 50% of its initial activity in about 24 hours at 90 ppb, or 90 days a 1 ppb. In contrast, the UV114 activity would reach 50% of its initial activity in 550 days of continuous operation when challenged with 1 ppb hexamethyldisiloxane if the deactivation rate is proportional to the siloxane concentration.

In one example, the photocatalyst has a skeletal or crystallite density of 3.84 g/cm3 and a surface area of greater than 50 m2/gram in pores 4 nm or greater diameter as measured with nitrogen by adsorption. In another example the surface area in pores greater than or equal to 4 nm diameter be greater than 50 m2/gram where the surface area and pore diameter is measured with nitrogen by adsorption and the data analyzed by the BJH method. As other photocatalytic oxides with different densities may be used, this can be expressed as greater than about 190 m2/gram of photocatalytic skeletal volume. In these examples, the conventional BET specific surface area measurement of m2/g is used for convenience.

Further experimental details are described herein for typical measurements of photocatalyst deactivation. Substrates were coated with an aqueous suspension of P25 Degussa titania and allowed to dry. The P25 coating was positioned to absorb 100% of the incident light when used in a flat plate photocatalytic reactor with UV illumination provided by two black-light lamps (SpectroLine XX-15A). The spectral distribution was symmetric about a peak intensity located at 352 nm and extended from 300 nm to 400 nm. The intensity was selected by adjusting the distance between the lamp and the titania-coated substrate. UV intensity at the reactor surface was measured by a UVA power meter (Oriel UVA Goldilux). High-purity nitrogen gas was passed through a water bubbler to set the desired humidity level. The contaminants were generated either from a compressed gas cylinder such as Propenal/N2, or a temperature controlled bubbler. An oxygen gas flow was then combined with the nitrogen and contaminant flows to produce the desired carrier gas mixture (15% oxygen, 85% nitrogen).

The titania-coated aluminum or gas slides were placed in a well milled from an aluminum block, and covered by a quartz window (96 percent UVA transparent). Gaskets between the quartz window and aluminum block created a flow passage of 25.4 mm (width) by 2 mm (height) above the titania-coated slides.

Contaminated gas entered the reactor by first passing through a bed of glass mixing beads. Next, the gas flow entered a 25.4 mm by 2 mm entrance region of sufficient length (76.2 mm) to produce a fully-developed laminar velocity profile. The gas flow then passed over the surface of the titania-coated glass-slides. Finally, the gas passed through a 25.4 mm by 2 mm exit region (76.2 mm long) and a second bed of glass beads before exiting the reactor.

The longevity of various TiO2 based photocatalysts in the presence of 90 ppb hexamethyldisiloxane was determined using the above reactor. The deactivation rate was determined by the slope of a straight line best representing the catalyst performance during its initial stages of operation. The P25 value represents the average results from multiple tests. The rate of activity loss expressed in % initial activity per hour becomes smaller, that is tends towards zero as the surface area in m2/g in pores greater than or equal to 6 nm becomes larger. This is not the case with the BET surface area, or the surface area in pores greater than 4 nm in diameter as determined by N2 adsorption and BJH analysis of this adsorption as performed by a Micromeritics ASAP 2010 surface area determination unit.

Although the foregoing examples refer to titanium dioxide, other photocatalyst may also be formed, such as suitably doped titanium dioxide where the dopant increases the photocatalytic activity, and metal oxide grafted titanium dioxide catalysts, such as, but not limited to tungsten oxide grafted TiO2. The present invention also contemplates the formation of photocatalytic mixed metal oxides such as, but not limited to, tin oxide (SnO2), indium oxide (In2O3), zinc oxide (ZnO), iron oxides (FeO and Fe2O3), neodymium oxide (Nd2O3) and cerium oxide (CeO2).

In addition to photocatalytic applications, porous metal oxide materials may be used in many other applications. For example, porous metal oxides may be used in separation technology applications, electrode applications and sensor applications.

Porous metal oxides may be formed into membranes that selectively separate one or more materials from a liquid or a gas. These membranes may be resistant to corrosive liquids and gases, and are stable at temperatures ranging from 500-800° C. For example, membranes may be used to capture iron oxides, carbon dioxide and other undesirable fossil fuel combustion products, and membranes may be used to separate chemicals and wastes from pulp and paper manufacturing process water.

Porous metal oxides may also be used as water purification filter materials. In one example, metal oxides are used in reverse osmosis membranes. These membranes are resistant to disinfectants such as chlorine and may be steam treated to reduce biofouling.

Porous metal oxides may also be used as electrodes in battery systems. For example, manganese oxides may be used in battery systems, and tin oxides or titanium oxide/tin oxide mixtures may be used in lithium ion battery systems.

Porous metal oxides may also be used in sensor applications. For example, sensors formed of metal oxides may be used to detect combustible and toxic gases. The performance (i.e. the sensitivity, selectivity and stability) of such sensors is directly related to the exposed surface volume. Therefore, the tailored porous metal oxide particles may improve the performance of metal oxide sensors because of the pore structure and increased surface area.

Porous metal oxides also may be used as a catalyst. Porous metal oxides can interact with atoms, ions and molecules throughout the bulk of the material because of the pore structure. The pores may control the diffusion of reagents and products into and out of the porous metal oxide. The pores also may control the reaction intermediates that may form within the pores. Metal oxides such as, but not limited to, titanium and zirconium based metal oxides may be used in catalyst applications.

Further, although the forgoing examples refer to using titanium precursors, other metals precursors may be used. Any metal that may be prepared as an alkoxide is a suitable precursor to create porous metal oxide nanoparticles. Example precursors include but are not limited to: cobalt, gallium, germanium, hafnium, iron, nickel, niobium, molybdenum, lanthanum, rhenium, scandium, silicon, tantalum, tungsten, yttrium and zirconium based precursors and mixtures thereof.

Although the present invention has been described with reference to preferred embodiments, workers skilled in the art will recognize that changes may be made in form and detail without departing from the spirit and scope of the invention.

1. A method of forming a porous metal oxide, the method comprising:
creating a metal oxide material with a controlled surface area and pore size distribution with a hydrolysis reaction in solution, where the hydrolysis reaction or reaction products of a metal oxide precursor react simultaneously or in conjunction with a metal salt or a disassociation species of a metal salt;
conditioning the metal oxide material; and
refining the metal oxide material to produce metal oxide particles having a porous structure containing crystallites.

2. The method of claim 1, wherein the solution includes an aqueous solvent.

3. The method of claim 1, wherein the solution includes a mixture of aqueous solvent and nonaqueous solvent.

4. The method of claim 1, wherein the solution includes a polymer.

5. The method of claim 4, wherein the polymer comprises polyethylene glycol.

6. The method of claim 1, wherein the solution further includes at least one of an acid, a salt, and a base.

7. The method of claim 6, wherein the solution includes an acid.

8. The method of claim 7, wherein the acid comprises acetic acid.

9. The method of claim 1, wherein the solution further includes an oligomer.

10. The method of claim 1, wherein the solution further includes a surfactant.

11. The method of claim 1, wherein the solution further includes a chelating agent.

12. The method of claim 1, wherein the solution further includes a metal salt of a metal that when combined with oxygen forms a metal oxide semiconductor.

13. The method of claim 12, wherein the metal salt comprises at least one of salts of tin, indium, zinc, iron, neodymium, and cerium.

14. The method of claim 1, wherein the metal oxide precursor includes halogen substituents.

15. The method of claim 1, wherein the metal oxide precursor comprises at least one selected from the group consisting of cobalt, gallium, germanium, hafnium, iron, nickel, niobium, molybdenum, lanthanum, rhenium, scandium, silicon, tantalum, tungsten, yttrium and zirconium precursors, and mixtures thereof.

16. The method of claim 1, wherein the crystallites are semiconductor crystallites.

17. The method of claim 1 and further comprising:
aging the metal oxide material after the hydrolysis reaction is complete.

18. The method of claim 1, wherein conditioning the metal oxide material comprises:
filtering the metal oxide material.

19. The method of claim 1, wherein conditioning the metal oxide material comprises:
refluxing the metal oxide material with a solvent.

20. The method of claim 19, wherein the solvent has a lower surface tension then water.

21. The method of claim 19, wherein conditioning the metal oxide material further comprises:
removing the solvent by rotoevaporation.

22. The method of claim 1 and further comprising:
applying the metal oxide particles to a substrate surface to form a film.

23. The method of claim 22, wherein applying the metal oxide particles comprises:
forming a slurry containing the metal oxide particles; and
applying the slurry to the substrate surface.

24. The method of claim 23, wherein forming a slurry comprises mixing the particles with a solvent.

25. The method of claim 23, wherein applying the slurry comprises one of spray coating, dip coating, electrostatic coating, or thermal treatment.

26. The method of claim 23 and further comprising:
drying the slurry on the substrate surface.

27. A method of forming a porous metal oxide, the method comprising:
forming a metal oxide material with a hydrolysis reaction in solution, where the hydrolysis reaction or reaction products of a metal oxide precursor react simultaneously or in conjunction with a metal salt or the disassociation species of a metal salt;
aging of a metal oxide material produced by the hydrolysis reaction;
filtering a metal oxide material produced by the hydrolysis reaction;
refluxing the metal oxide material with a solvent having a lower surface tension than water;
removing the solvent from the metal oxide material;
calcining the metal oxide material;
forming an aqueous slurry of the porous metal oxide material; and
applying the aqueous slurry to a surface of a substrate to form a metal oxide film.
